(19) United States
(12) Patent Application Publication
(10) Pub. No.: US 2014/0205428 A1
(43) Pub. Date: Jul. 24, 2014

(54) Method for Primary Adjustment of a Hydroelectric Power Plant

(71) Applicants: Sven Brausewetter, Neu-Ulm (DE); Thomas Kachele, Heidenheim (DE); Wolfgang Kerler, Aarau Rohr (CH); Manfred Stummer, Heidenheim (DE)

(72) Inventors: Sven Brausewetter, Neu-Ulm (DE); Thomas Kachele, Heidenheim (DE); Wolfgang Kerler, Aarau Rohr (CH); Manfred Stummer, Heidenheim (DE)

(73) Assignee: Voith Patent Gmbh, Heidenheim (DE)

(21) Appl. No.: 14/127,905

(22) PCT Filed: Jul. 25, 2012
(86) PCT No.: PCT/EP2012/003127

§ 371 Date: Mar. 18, 2014

(30) Foreign Application Priority Data
Oct. 7, 2011 (DE) 10 2011 115 034.3

(51) Int. Cl. F03B 15/16

(52) U.S. Cl. CPC F03B 15/16
USPC 415/1; 415/13

(57) ABSTRACT

The invention relates to a method for primary adjustment of a hydroelectric power plant comprising a dual adjustment turbine, at least one first actuator, and at least one second actuator, wherein the first and second actuators are reset depending upon an actual value of a network frequency of an electrical network which receives the generated electrical power for influencing the turbine output in order to achieve a target value of the network frequency. The invention is characterised in that the first actuators are only operated in predefined actuating steps, and then an adjustment to the target value of the network frequency is performed by resetting the second actuators.

The invention relates to a method for primary adjustment of a hydroelectric power plant of the kind defined in closer detail in the preamble of claim 1.

Hydroelectric power plants are known from the general state of the art. They utilize a difference in height between the so-called headwater and the so-called tailwater in order to conduct the water during the flow from the headwater to the tailwater through a turbine. The difference in pressure originating from the difference in height is converted into mechanical energy in the region of the turbine. The turbine will then drive a generator which converts the mechanical energy into electrical power in order to provide said power for electrical consumers. Hydroelectric power plants are typically used in such a way that the electric power generated in the region of the hydroelectric power plants is provided to an electric power supply network. It is a fact that electric power supply networks typically have a predetermined network frequency. In order to ensure the functionality of the network, it is important to keep this network frequency within specific predetermined boundaries. The supplied electric power is adjusted for this purpose in such a way that it contributes to the support of a stable network frequency. This is known in power plant engineering as primary adjustment or primary control.

The primary adjustment in the region of a hydroelectric power plant typically occurs in such a way that actuators are adjusted for influencing the electrical power in the turbine depending on an actual value of the network frequency for influencing the turbine power in order to achieve a target value of the network frequency. This procedure is known from the general state of the art. It requires turbines with respective actuators which can be adjusted with a comparatively large number of the actuating movements per unit of time in order to meet the requirements of primary adjustment that are placed on the turbine.

The utilization of actuators in the region of water turbines is especially efficient and precisely possible in so-called dual-control turbines. Such turbines can be a Pelton or free-jet turbine, in which a so-called deflector is present as an actuator which at least partly deflects the free jet to the turbine in order to influence the power on the one hand, and in which a nozzle valve is present as a second actuator on the other hand which respectively influences the flow cross-section of the free jet. A further, very common example for a dual-control turbine is especially a Kaplan turbine, which comprises adjustable turbine blades or vanes as first actuators, and which typically comprises a guide apparatus with guide blades as the second actuator. The actuating movements of the turbine blades and the guide blades are usually coupled via the so-called “optimal correlation”. This ensures that the settings of the two actuators with respect to each other can always only occur in such a way that the optimal efficiency of the Kaplan turbine is achieved. The so-called optimal correlation therefore represents an efficiency-optimized forced coupling of the actuating movements of the first and the second actuators.

It is the object of the present invention to realize a high operational lifespan of the bearing and the mechanical actuators of the installation under high control precision when using a dual-control turbine for primary adjustment in a hydroelectric power plant.

This object is achieved in accordance with the invention by the features mentioned in the characterizing part of claim 1. Further advantageous embodiments of the method in accordance with the invention are provided in the sub-claims which are dependent thereon.

The method in accordance with the invention provides that the first actuators are displaced only in predefined actuating steps and that adjustment to the target value of the network frequency occurs by adjusting the second actuators.

The invention is especially based on the fact that the first actuators are displaced merely in predetermined step widths. According to a preferred further development, these step widths lie at more than 0.25% of the entire actuating path of the first actuators, preferably between 0.5% and 5% of the entire actuating path. Such an adjustment of the first actuators by a comparatively large predetermined step will then require subsequent control or adjustment of the second actuators in order to ideally achieve the target value of the network frequency on the basis of the set power of the turbine. If a Kaplan turbine is concerned, the configuration will cancel the initially described so-called optimal correlation. As a result, the method in accordance with the invention can therefore be accompanied by minimal losses concerning the efficiency. However, the method in accordance with the invention leads to fewer actuating movements, at least of the first actuators, which are further provided with a larger actuating path. The reduction in the number of the actuating movements already leads to a considerable relief in the bearing and the mechanical actuators, so that a far longer operational lifespan can be achieved in this case or, in the case of the same operational lifespan, a considerably simpler and cheaper bearing concept for the first actuators. Furthermore, the individual actuating movements will become larger. As a result, the lubrication or the possibility to establish a hydrodynamic lubricating film if slide bearings are used is improved considerably. This also has a positive effect on the operational lifespan in the case of an identical bearing configuration or a positive effect on the possible simplification of the bearing with an operational lifespan that is determined itself.

In the case of average efficiency losses of less than 0.1%, a reduction in the actuating movements of the first actuators by a factor of 10 to 20 was achieved in respect of tests. Losses in efficiency of virtually 0% were often also achieved in simulations and measurements, and in individual cases it was managed to detect even minimal increases in the efficiency. This configuration thus allows achieving a higher operational lifespan or, as already mentioned, a considerable simplification of the bearings in combination with the same operational lifespan. This offers advantages concerning the constructional effort, the overall space, the weight and the costs.

It is provided in an especially appropriate and advantageous further development of the method in accordance with the invention that the actuating steps are predetermined depending on the current operating point of the turbine or the machine set consisting of turbine and generator. This variation in the magnitude of the actuating steps depending on the operating point of the turbine allows very high quality in the control in combination with a minimum number of actuating movements.

It is further provided in a further very appropriate and advantageous embodiment of the method in accordance with the invention that in the event that more than one actuating step needs to be taken with the first actuators the predetermining of the defined actuating step is omitted and the new position of the first actuators is accessed in one step. In the special case that the expected actuating movement of the first actuators is larger than the currently applicable step width, the method in accordance with the invention provides a cancellation of the method in accordance with the invention. This would mean in connection with the aforementioned example of the Kaplan turbine that the so-called optimal correlation is reinstated, so that the first actuators will pass the entire required actuating width in one pass, i.e. in one single movement. The method in accordance with the invention will then be reapplied if the expected actuating movement is smaller than or equal to an actuating step. The method in accordance with the invention offers special advantages in order to avoid a plurality of small actuating steps and to reduce them by predetermining a defined value according to the actuating width. If larger required displacement paths of the first actuators occur, it may be especially efficient and advantageous if the method in accordance with the invention is suspended in order to prevent several directly successive actuating steps and to cover the required actuating value in one single pass.

It is further provided in an advantageous embodiment of the method in accordance with the invention that the actual value of the network frequency is filtered with an electronic filter before it is used as an input quantity for the adjustment or displacement of the first and second actuators. Such an electronic filter can advantageously be used in order to minimize the noise of the signal of the network frequency. In combination with the idea in accordance with the invention to only move the first actuators in predefined actuating steps, the number of the required actuating movements is minimized even further without thus impairing the quality of primary adjustment.

It can further be provided in an especially appropriate further development of this embodiment of the method in accordance with the invention that the electronic filter is arranged as a dead band filter with a sliding dead band. Such a dead band filter with sliding dead band especially allows a very efficient filtering of the noise, because the sliding dead band slidingly follows the average value of the actual signal and filters out the noise around the same by the dead band. This allows an especially efficient minimization in the required actuating movements.

It is further provided in a highly appropriate and advantageous embodiment that a gradient and a change amplitude of the input signal of the dead band filter is determined, wherein the dead band filter is temporarily suspended in a gradient which is larger than a predetermined limit value and a change amplitude which is also larger than a predetermined limit value. As a result of this additional trick in the method, a further optimization of the dead band filter with sliding dead band is achieved. As soon as very strong changes in the signal are registered, which are accompanied by a very high gradient of the input signal, the dead band filtering will be suspended temporarily in order to enable a rapid response to very strong dynamic changes. Since the sliding dead band always entails a certain delay, this embodiment in accordance with the invention is very advantageous when a rapid reaction to a strong rise or drop in the network frequency is concerned.

It is further provided in an especially advantageous further development that as long as the dead band filter is suspended noise suppression by the electronic filtering will still occur. The electronic filtering of the optimized dead band filter can therefore be arranged in such a way even when the dead band filter is suspended (e.g. by integration) a noise of the signal is suppressed in order to ensure rapid, reliable and precise control even in these situations.

Further advantageous embodiments of the method in accordance with the invention are further provided from the remaining dependent claims. They are also explained from the embodiment which is described below in closer detail by reference to the drawings, wherein:

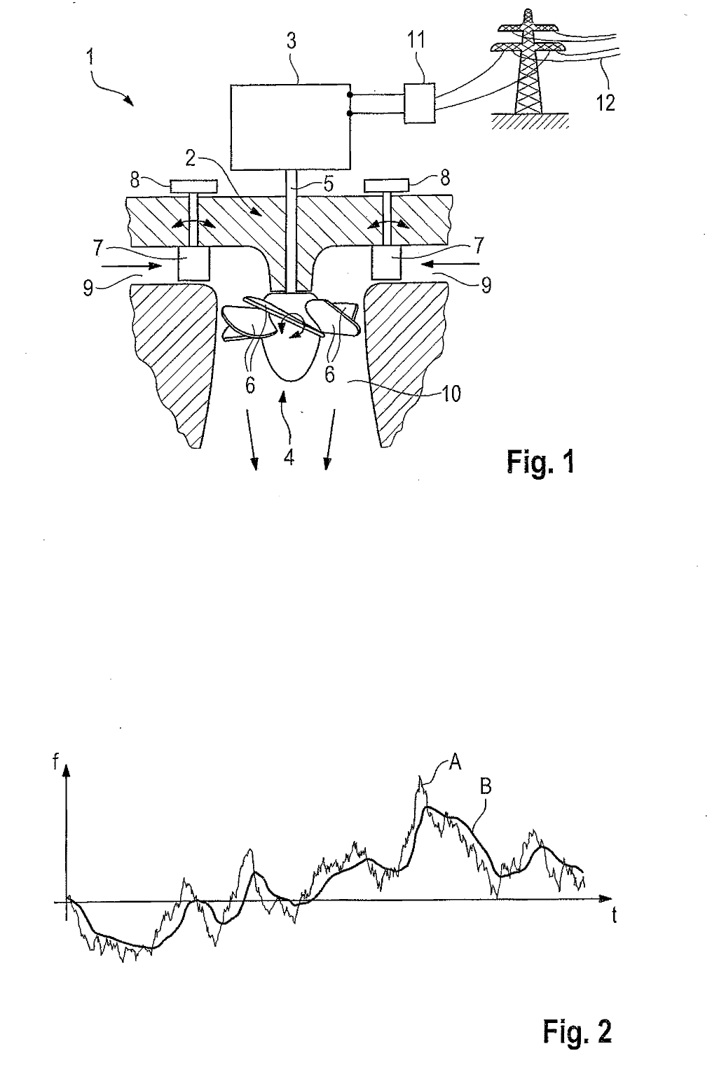

FIG. 1 shows a principal view of a section of a hydroelectric power plant which is relevant for the invention, and

FIG. 2 shows a measured curve of a network frequency and a filtered actual value generated therefrom as a control input quantity.

The illustration of FIG. 1 shows a section of a hydroelectric power plant 1 which is relevant for the invention and which is not shown in its entirety. The core of the illustrated section is formed by a machine set 2, which comprises a generator 3 and a Kaplan turbine 4. They are connected via a common shaft 5, which in the illustrated embodiment is arranged parallel to gravity. The Kaplan turbine 4 per se comprises so-called turbine blades 6, which are also known as vanes. As is indicated on the basis of an example one of the turbine blades 6 by a double arrow, these turbine blades 6 are adjustably arranged. They form the first actuators of the Kaplan turbine 4, which is arranged in its entirety as a dual-control turbine 4. The second actuators are formed by the guide blades 7 in a guide apparatus, which influences the supply of the water to the Kaplan turbine 4. They thus influence the quantity of water which flows through the so-called pressure pipe from headwater of the hydroelectric power plant 1 via the spiral 9 to the Kaplan turbine 4. Once the turbine 4 has been passed, the water flows via a so-called draft tube 10 into the tailwater.

A pressure difference in the water occurs by the fall of water between the headwater and the tailwater, which drives the Kaplan turbine 4. The generator 3 is then driven by the common shaft 5 and provides electric power. This electric power reaches an electric supply network 12 via an indicated electronic system 11, which supply network is indicated by way of example in the illustration of FIG. 1 by reference to a mast.

In order to ensure sufficient network stability in the region of the electric supply network 12, it is important that the network frequency is kept constant within comparatively narrow limits in the electric supply network 12. The typical network frequency in Europe is approximately 50 Hz and in the United States approximately 60 Hz. The hydroelectric power plant 1 supports the constancy of the network frequency by the so-called primary adjustment. This means that the power supply of the generator 3 to the electric network 12 is adjusted on the basis of the network frequency. For this purpose, the dual-control turbine 4 or its respective two actuators are triggered accordingly, i.e. the turbine blades 6 as the first actuators and the turbine blades 7 as the second actuators.

It is a fact concerning the primary adjustment according to the state of the art that the so-called optimal correlation applies for optimizing the efficiency of the dual-control turbine 4 between the actuating movements of the guide blades 7 as the second actuators and the turbine blades 6 as the first actuators. This means that the actuating movements are always performed in an optimal correlation with respect to each other. The efficiency of the turbine 4 can be optimized in this way. The triggering of the dual-control turbine 4 by the network frequency leads to a very high number of actuating movements, because very rapid fluctuations occurs in the typical network frequency and noise can further occur. In a frequency curve f over time t, as shown in the illustration of FIG. 2 on the basis of the line designated with A, approximately 2500 to 3000 changes in the triggering of the turbine blades 6 or the guide blades 7 were registered within one hour of operation based on the example of the Kaplan turbine 4 illustrated here. The bearings of the turbine blades 6 and the guide blades 7 must therefore be designed to cope with a comparatively large number of actuating movements which partly have only very short paths of displacement. This makes the bearings comparatively large, complex and expensive.

The method in accordance with the invention is concerned with the number of the required actuating movements. It is the goal to reduce these movements in order to achieve a comparable operational lifespan with simpler and cheaper bearings or a longer operational lifespan with comparable bearings. This is achieved in such a way that an adjustment of the turbine blades 6 as the first actuators only occurs with predefined actuating steps. The quality of the control can be maintained via the guide blades 7. The bearing is less problematic in this case because it can be arranged in a simpler and more efficient manner in the stationery guide apparatus than in the region of the rotating Kaplan turbine 4. The predetermined actuating steps of the first actuators will be predefined in a rather large way, preferably in the magnitude of 0.5% to 5% of the entire possible adjusting path between the one stop and the other stop of the turbine blades 6. The number of the required turbine blades 6 is reduced by this predetermination and by the necessity to merely move the first actuators in steps. The guide blades 7 of the guide apparatus will then adjust to the target value of the network frequency.

The number of actuating movements, especially of the turbine blades 6, is thus reduced. At the same time, the path of displacement is increased within each individual actuating movement. As a result of the longer path of displacement, this leads to the possibility of an improved hydrodynamic lubricating film in the bearings which are typically arranged as slide bearings. In addition to the reduction in the number of actuating movements, this contributes essentially to the improvements in the bearing. Much higher operational lifespans can be achieved in this manner with comparably arranged bearings, or the bearings can be arranged in a clearly simpler way and therefore more inexpensive and more compact.

It can additionally be provided that the actual value of the network frequency is filtered via an electronic filter in order to suppress noise and to thus produce a minimization in the required actuating movements in the region of the Kaplan turbine 4. A simple PT1 filter can be used for this purpose, which merely reduces the noise in the actual signal. A dead band filter can preferably be used, which completely filters respective frequencies which occur for example as harmonics in the frequency signal. A dead band filter is especially ideal which operates with the so-called sliding dead band. This means that the dead band filter slidingly follows an average value of the input signal. The only problem in such a sliding dead band filter occurs when a rapid rise or drop occurs in the optimized dead band filter. It can therefore be provided for such situations in an optimized dead band filter with sliding dead band that the dead band filter is temporarily deactivated when a rise or drop in the input signal occurs which is too sharp and too large. The gradient and the change amplitude of the input signal can be monitored for this purpose. If they change by more than a predetermined limit value, the dead band filter will be deactivated temporarily and will only be activated again after the decrease of the gradient and the change amplitude. In order to obtain noise suppression even in this situation with deactivated dead band filter, the electronic filter can be arranged in such a way that this noise suppression occurs by a PT1 filter element or especially by integration when the dead band filter is deactivated.

Such a dead band filter with sliding dead band and a function block for deactivating the dead band in the case of rapid and large changes in the input signal will be referred to below as an optimized dead band filter.

If such an optimized dead band filter is used, the filtered value represented by line B is obtained from the actual value A of the network frequency. The optimized dead band filter ensures that the output signal, i.e. the filtered value B, follows the input signal, i.e. the actual value A of the network frequency, in a more rapid manner and therefore with considerably less damping and therefore in a much more precise way. This filtered value B can then be used as an input quantity B for triggering the turbine blades 6 and the guide blades 7. As a result, optimized triggering of the two actuators of the Kaplan turbine 4 is achieved in this way. When using the aforementioned example, even the very simple PT1 filter which merely suppresses the noise of the signal, in combination with the idea in accordance with the invention to adjust the turbine blades 6 in predetermined actuating steps, it is possible to achieve a reduction in the number of actuating movements in the turbine blades 6 by a factor of up to 20, e.g. from 3000 to approximately 150 actuating movements. The actuating movements of the guide blades 7 are reduced approximately by the factor 3 from approximately 2500 to approximately 800 actuating movements. If on the other hand the optimized dead band filter is used, a further low reduction in the number of actuating movements of the turbine blades 6 is possible, i.e. the actuating movements of the guide blades 7 can thus be reduced again by the factor of 1.5 to 2.5. In summary, the described method in combination with the optimized dead band filter provides a reduction in the actuating movements of the turbine blades 6 by more than the factor 20 and a reduction in the actuating movements of the guide blades 7 to less than ⅙^{th} of the originally required actuating movements. Primary adjustment is thus not subject to any relevant quality losses. Since the optimal correlation between the actuating movements of the guide blades 7 and the turbine blades 6 needs to be relinquished for applying the method in accordance with the invention, there will be a minimal reduction in the average efficiency, which typically lies clearly beneath 0.1% however. As a result of the extended operational lifespan and the reduction in the costs for the bearing and the resulting savings, this advantage will typically outweigh any disadvantages.

If a jump occurs in the actual frequency during the application of the method in accordance with the invention it may principally be necessary—depending on the predetermined size of the actuating step—that several actuating steps need to be performed in a directly successive way. In this case, where a movement is expected which has a path of displacement of more than one actuating step, the method in accordance with the invention can be briefly suspended. In the example of the Kaplan turbine 4 the optimal correlation is temporarily produced again, and the guide blades 7 and the turbine blades 6 will travel to the end point predetermined by the control according to this correlation. The method for the reduction of the actuating movements will then commence operation again. It is prevented in this way that in the case of larger actuating movements they will be performed in several individual steps. This would rather be a disadvantage than an advantage concerning the bearing and especially concerning the hydrodynamic lubricating film in this case, since the movement, which could otherwise be performed in one pass, would have to be interrupted in this way. The suspension of the described method for these special cases which occur comparatively rarely is therefore useful and can further support the relief of the bearings.

1-11. (canceled)

12. A method for the primary adjustment of a hydroelectric power plant including a dual-control turbine, at least one first actuator, at least one second actuator, wherein the first and second actuators are adjusted for influencing the turbine power depending on an actual value of a network frequency of an electric network receiving the generated electric power in order to reach a target value of the network frequency, and wherein a Kaplan turbine with turbine blades as the first actuators and guide blades of a guide apparatus as second actuators is used as a turbine, the method comprising:
displacing the first actuators only in defined predetermined actuating steps, and thereafter adjusting the target value of the network frequency by adjusting the second actuators.

13. The method according to claim 12, wherein the actuating steps of the first actuators are predetermined with at least 0.5%, preferably with a value of between 0.5% and 5%, of the total actuating path of the first actuators.

14. The method according to claim 12, wherein the actuating steps are predetermined depending on the current operating point of the turbine.

15. The method according to claim 13, wherein the actuating steps are predetermined depending on the current operating point of the turbine.

16. The method according to claim 12, wherein in the event that more than one actuating step needs to be made with the first actuators the predetermination of the defined actuating step is terminated and the new position of the first actuators is accessed in one pass.

17. The method according to claim 13, wherein in the event that more than one actuating step needs to be made with the first actuators the predetermination of the defined actuating step is terminated and the new position of the first actuators is accessed in one pass.

18. The method according to claim 14, wherein in the event that more than one actuating step needs to be made with the first actuators the predetermination of the defined actuating step is terminated and the new position of the first actuators is accessed in one pass.

19. The method according to claim 15, wherein in the event that more than one actuating step needs to be made with the first actuators the predetermination of the defined actuating step is terminated and the new position of the first actuators is accessed in one pass.

20. The method according to claim 12, wherein the actual value of the network frequency is filtered by an electronic filter before it is used as an input quantity for the adjustment of the first and second actuators.

21. The method according to claim 20, wherein the electronic filter is arranged as a dead band filter with a sliding dead band.

22. The method according to claim 21, wherein a gradient and a change amplitude of an input signal of the dead band filter is determined, wherein the dead band filter is temporarily suspended in a gradient which is larger than a predetermined limit value and a change amplitude which is larger than a predetermined limit value.

23. The method according to claim 22, wherein noise suppression by the electronic filter will continue as long as the dead band filter is suspended.

24. The method according to claim 12, wherein the optimal correlation between the turbine blades and the guide blades is suspended as long as the first actuators are displaced in predetermined actuating steps.

25. A hydroelectric power plant comprising:
a dual-control turbine;
at least one first actuator; and
at least one second actuator, wherein the first and second actuators are adjusted for influencing the turbine power depending on an actual value of a network frequency of an electric network receiving the generated electric power in order to reach a target value of the network frequency, and wherein a Kaplan turbine with turbine blades as the first actuators and guide blades of a guide apparatus as second actuators is used as a turbine; wherein the first actuators are only displaced in defined predetermined actuating steps, and thereafter an adjustment occurs to the target value of the network frequency by adjusting the second actuators.

26. The hydroelectric power plant according to claim 25, wherein the actuating steps of the first actuators are predetermined with at least 0.5%, preferably with a value of between 0.5% and 5%, of the total actuating path of the first actuators.

27. The hydroelectric power plant according to claim 25, wherein the actuating steps are predetermined depending on the current operating point of the turbine.

28. The hydroelectric power plant according to claim 26, wherein the actuating steps are predetermined depending on the current operating point of the turbine.

29. The hydroelectric power plant according to claim 25, wherein in the event that more than one actuating step needs to be made with the first actuators the predetermination of the defined actuating step is terminated and the new position of the first actuators is accessed in one pass.

30. The hydroelectric power plant according to claim 26, wherein in the event that more than one actuating step needs to be made with the first actuators the predetermination of the defined actuating step is terminated and the new position of the first actuators is accessed in one pass.

31. The hydroelectric power plant according to claim 27, wherein in the event that more than one actuating step needs to be made with the first actuators the predetermination of the defined actuating step is terminated and the new position of the first actuators is accessed in one pass.
